(19) United States
(12) Patent Application Publication
(10) Pub. No.: US 2005/0082713 A1
(43) Pub. Date: Apr. 21, 2005

(54) Method of making oriented polychlorotrifluoethylene films

(76) Inventor: Carl E. Altman, Pitman, PA (US)

Correspondence Address: Honeywell International Inc., 15801 Woods Edge Road, Colonial Heights, VA, 23834, US

(21) Appl. No.: 10/688,694

(22) Filed: Oct. 17, 2003

(51) Int. Cl. B29C 55/00

(52) U.S. Cl. 264/210.1; 264/288.4

(57) ABSTRACT

A process for the manufacture of oriented polychlorotrifluoroethylene (PCTFE) films, wherein molten PCTFE resin is extruded into a crystalline film and the films are oriented with a stretch ratio of at least about 1.5:1. The resulting films have excellent water vapor barrier properties while retaining their other advantageous properties.

### BACKGROUND OF THE INVENTION

1. Field of the Invention

This invention relates to oriented films of polychlorotrifluoroethylene polymers.

2. Description of the Prior Art

Films formed of poly(chlorotrifluoroethylene) (PCTFE) homopolymers and copolymers are known. They have excellent transparency and moisture barrier properties. These films and structures including the films have been used in many demanding applications, including packaging of pharmaceuticals and other products in the health care industry, electroluminescent lamps, etc.

Films of PCTFE homopolymers and copolymers are commercially available from Honeywell International Inc. (Morristown, N.J. USA) under the Aclar® trademark. Typically, such films are sold as a monolayer structure and are formed into multilayered structures for the particular packaging application. One major use of these films is in the well-known blister package application, where a layer of PCTFE film is adhered to another film layer, typically a layer of polyvinylchloride (PVC) film. This structure is then thermoformed into a blister package with receptacles for individual pharmaceutical units (e.g., pills) and the like. Once filled with the desired product, typically a layer of aluminum foil (and, preferably other layers) is adhered to the underside of the package. The individual unit is dispensed by pushing the unit from the blister side through the foil. This type of packaging has been widely used in the industry.

Methods of making films and film structures from PCTFE polymers and copolymers are known in the art. These are shown, for example, in U.S. Pat. Nos. 6,555,190; 6,432,542; 6,306,503; 5,945,221; 5,874,035; 6,238,607; 6,465,103 and 5,139,878.

Typically, a monolayer film of PCTFE is made in a conventional film extrusion process, wherein PCTFE resin is fed to a feed hopper of an extruder, molten resin is extruded onto a casting roll where the film is formed and one or more cooling rolls are used to cool the film prior to windup.

U.S. Pat. No. 4,544,721 to Levy discloses stretched or oriented films of PCTFE homopolymers and copolymers. However, this patent requires that the film which is to be stretched be substantially amorphous and that stretching be conducted within a narrow stretch zone.

It would be desirable to provide oriented films of PCTFE homopolymers and copolymers by a different process.

### BRIEF SUMMARY OF THE INVENTION

In accordance with one aspect of this invention, there is provided a method of forming a film from a PCTFE polymer, the method comprising the steps of:
a) extruding molten PCTFE polymer;
b) cooling the PCTFE polymer to a temperature below its melting point to form a film that is crystalline; and
c) orienting the PCTFE film while it in its crystalline state by stretching the film at a stretch ratio of at least about 1.5:1 while holding the film under tension;
wherein the resulting PCTFE film has a water vapor transmission rate of less than about 0.05 g/100 in²/day (0.775 g/m²/day).

In accordance with another aspect of this invention, there is provided a method of forming a film from a PCTFE polymer, the method comprising the steps of:
a) extruding molten PCTFE polymer onto a casting roll;
b) cooling the PCTFE polymer to a temperature below its melting point on the roll to form a film that is crystalline; and
c) orienting the PCTFE polymer film while in its crystalline state by stretching the film between at least one relatively slow draw roll and at least one relatively fast draw roll at a stretch ratio of at least about 1.5:1 while holding the film under tension; and
d) collecting the oriented PCTFE polymer film;
wherein the resulting PCTFE film has a water vapor transmission rate of less than about 0.05 g/100 in²/day (0.775 g/m²/day).

In accordance with this invention, it has been found that the PCTFE polymer films can be oriented in their crystalline state to provide films with excellent water vapor barrier properties while maintaining their other desirable mechanical and chemical properties. It has been found that it is not necessary to utilize an amorphous film of PCTFE before it is oriented in order to obtain such properties.

One advantage of the process of this invention is that the orientation is simpler and can be done in-line with the manufacture of the film. Alternatively, the film may be extruded and cast in one step, collected and oriented in a separate second step.

### DETAILED DESCRIPTION OF THE INVENTION

For purposes of this invention, the terms “orienting” and “stretching” shall be used interchangeably.

As used herein, the term “PCTFE polymer” includes both homopolymers and copolymers of chlorotrifluoroethylene monomer, as well as mixtures thereof As used herein, “copolymers” shall include polymers having two or more monomer components. Such copolymers may contain up to 10%, and preferably up to 8% by weight of other comonomers such as vinylidine fluoride and tetrafluoroethylene. Most preferred are chlorotrifluoroethylene homopolymers and copolymers of chlorotrifluoroethylene and vinylidine fluoride and/or tetrafluoroethylene.

The films of this invention are first formed as unoriented films. These films may be formed by a casting process or a blown film process. In the former process, which is preferred, the PCTFE polymer material is fed into in-feed hopper of an extruder. The melted and plasticated stream from the extruder is fed into an extrusion die. After exiting the die, the film is cast onto a first controlled temperature casting roll, passes around the first roll, and then onto a second controlled temperature roll, which is normally cooler than the first roll. The controlled temperature rolls largely control the rate of cooling of the film after it exits the die. Additional rolls may also be employed. In the blown film process, a circular die head for bubble blown film is employed through which the plasticized extrudate from an extruder is forced and formed into a film bubble which is ultimately collapsed and formed into a film.

The temperature of the various rolls are selected to achieve the desired properties of the film and are also based on the type of PCTFE polymer employed (e.g., homopolymer or copolymer). Typically, the casting roll temperature is in the range of about 50 to about 250° F. (10 to 121° C.), preferably in the range of about 75 to about 200° F. (24 to 93° C.), and more preferably in the range of about 100 to about 175° F. (38 to 79° C.). The temperature of the second controlled temperature roll (also called a preheat roll) is typically in the range of about 50 to about 250° F. (10 to 121° C.), preferably in the range of about 75 to about 200° F. (24 to 93° C.), and more preferably in the range of about 100 to about 175° F. (38 to 79° C.). The temperature of the casting roll and preheat roll need not be the same.

The temperature of the slow and fast draw rolls may or not be the same. Typically, the temperature of the slow draw roll is in the range of about 75 to about 200° F. ( 24 to 93° C.), preferably in the range of about 90 to about 175° F. (32 to 80° C.), and more preferably in the range of about 100 to about 150° F. (38 to 66° C.). Typically, the temperature of the fast draw roll is in the range of about 150 to about 300° F. (66 to 149° C.), preferably in the range of about 180 to about 260° F. (82 to 127° C.), and more preferably in the range of about 200 to about 240° F. (93 to 116° C.). In addition, smaller nip rolls may be employed to press the film against each draw roll.

A cool roll may be employed to provide dimensional stability to the film. Typically, the temperature of this roll is in the range of about 50 to about 300° F (10 to 149° C.), preferably in the range of about 100 to about 250° F. (38 to 121° C.), and more preferably in the range of about 150 to about 225° F. (66 to 107° C.).

The formed film, prior to stretching, is crystalline. As used herein, the term “crystalline” means that X-ray diffraction patterns of the film show ordered sharp patterns as opposed to the diffusely scattered X-rays with substantially amorphous films. Typically, the films of this invention have a crystallinity, as measured by X-ray diffraction, of at least about 10%, preferably from about 10 to about 45%, more preferably from about 15 to 35% and most preferably from about 20 to about 30%. Alternatively, crystallinity can be measured by a technique calibrated to X-ray crystallinity, such as FT-IR or density column.

In accordance with this invention, the film is then stretched or oriented in any desired direction using methods well known to those skilled in the art. In such a stretching operation, the film may be stretched uniaxially in either the direction coincident with the direction of movement of the film being withdrawn from the casting roller, also referred to in the art as the “machine direction”, or in a direction which is perpendicular to the machine direction, and referred to in the art as the “transverse direction”, or biaxially in both the machine direction and the transverse direction.

Preferred draw ratios of orientation are from about 1.5:1 to 5:1 in at least one direction, more preferably from about 2:1 to about 3:1, and most preferably from about 2:1 to about 2.5:1. This results in improvements in strength and toughness properties, as well as an improved moisture vapor transmission rate.

During stretching, the film is held under tension, in any manner known in the art. For example, the film can be held under tension via an additional roll, such as the cold roll mentioned above.

The films of this invention may have any desirable thickness. For example, the film may have a thickness after orientation of from about 0.1 mil (2.5 μm) to about 15 mil (381 μm), more preferably from about 0.2 mil (5.1 μm) to about 5 mil (127 μm), and most preferably from about 0.5 mil (12.7 μm) to about 2 mil (50.8 μm). While such thicknesses are referenced, it is to be understood that other layer thicknesses may be produced to satisfy a particular need and yet fall within the scope of the present invention. The thickness of the film before stretching is selected such that the desired thickness after stretching is achieved, based on the stretch ratio employed, as is known in the art.

The films of this invention are useful as flat structures or can be formed, such as by thermoforming, into desired shapes. The films are useful for a variety of end applications, such as for medical packaging, pharmaceutical packaging, food packaging and other industrial uses. The films may be employed as pouches in the medical or food industry, or as overwraps for such pouches. The films are typically laminated to other polymeric films and utilized as a multilayer structure in packaging applications. The films of the invention may be thermoformed (e.g., after annealing as is known in the art) and are useful for forming three dimensionally shaped articles such as blister packaging for pharmaceuticals, or any other barrier packaging. This may be done by forming the film around a suitable mold and heating in a method well known in the art.

The water vapor transmission rate (WVTR) of such films of the invention may be determined via the procedure set forth in ASTM F1249. In the preferred embodiment, the film according to this invention has a WVTR per mil of film preferably less than about 0.05 or less g/100 in²/day (0.775 g/m²/day) at 37.8° C. and 100% RH, more preferably less than about 0.03 g/100 in²/day (0.465 g/m²/day), and most preferably less than about 0.015 g/100 in²/day (0.233 g/m²/day), as determined by water vapor transmission rate measuring equipment available from, for example, Mocon. Preferably, the films of this invention have water vapor transmission rates that are at least less than about 20%, more preferably at least less about 25% and most preferably at least less than about 30%, of the water vapor transmission rates of similar films which are unoriented.

### EXAMPLES

The following non-limiting examples serve to illustrate the invention.

### Example 1 (Comparative)

A monolayer film was extruded from PCTFE homopolymer from Honeywell International Inc. by feeding the resin to a 3.5 inch (89 mm) diameter single screw extruder. The melt temperature was 607° F. (319° C.) and the die temperature was 580° F. (304° C.). The extrudate was cast onto a casting roll whose temperature was 100° F. (38° C.) and then around a preheat roll whose temperature was 210° F. (99° C.). The film was then passed around two draw rolls (without stretching) maintained at temperatures of 230° F. (110° C.) and 240° F. (116° C.), respectively. The film was then passed over a cooling roll maintained at 150° F. (66° C.). The speed of each of the rolls was approximately the same. The results are shown in Table 1. The crystallinity levels are prior to any stretching.

### Example 2

Example 1 was repeated except that the film was monoaxially oriented at a draw ratio of 2:1 by adjusting the speed of the draw rolls. The slow draw roll temperature was 210° F. (99° C.) and the fast draw roll temperature was 230° F (110° C.). The results are shown in Table 1.

### Example 3

Example 2 was repeated using a draw ratio of 2.5:1, with the slow draw roll temperature 200° F. (99° C.). The results are shown in Table 1.

### Example 4

Example 2 was repeated using a draw ratio of 3:1, with the preheat roll temperature of 190° F. (88° C.). The results are shown in Table 1.

The physical properties of the films were tested and are shown in Table 2.

TABLE 1

| | | | Average | WVTR |
|---|---|---|---|---|
| | Crystallinity, | | Thickness, | g/100 in²/mil |
| Example | % | Draw Ratio | mils (μm) | (g/m²/mil) |
| 1 | 27.7 | 1:1 | 0.94 (23.9) | 0.0164 (0.2542) |
| 2 | 23.1 | 2:1 | 1.51 (38.4) | 0.0112 (0.1736) |
| 3 | 22.3 | 2.5:1 | 1.13 (28.7) | 0.0106 (0.1643) |
| 4 | 21.1 | 3:1 | 0.83 (21.1) | 0.0083 (0.1287) |

TABLE 2

| | Tensile Modulus | | Tensile Yield | | UTS | | Yield | | Graves | |
|---|---|---|---|---|---|---|---|---|---|---|
| | kPSI (MPa) | | kPSI (MPa) | | KPSI (MPa) | | Elong. % | | g/mil | |
| Ex. | MD | TD | MD | TD | MD | TD | MD | TD | MD | TD |
| 1 | 190 | 193 | 5.759 | 5.333 | 9.126 | 5.311 | 7.14 | 7.51 | 502 | 478 |
| | (1311) | (1332) | (39.73) | (36.80) | (62.97) | (36.65) | | | | |
| 2 | 223 | 192 | 8.132 | 5.612 | 14.035 | 5.017 | 7.51 | 7.51 | 552 | 564 |
| | (1539) | (1325) | (56.11) | (38.72) | (96.84) | (34.62) | | | | |
| 3 | 270 | 175 | — | 5.910 | 18.597 | 4.279 | — | 7.51 | 591 | 530 |
| | (1863) | (1208) | | (40.78) | (128.32) | (29.53) | | | | |
| 4 | 286 | 193 | — | 5.372 | — | 3.519 | — | 7.51 | 571 | 425 |
| | (1973) | (1332) | | (37.07) | | (24.28) | | | | |

As can be seen from the above tables, the films produced by the methods of this invention have improved water vapor barrier properties compared with unoriented film, and yet maintain their desirable mechanical properties.

Having thus described the invention in rather full detail, it will be understood that such detail need not be strictly adhered to but that further changes and modifications may suggest themselves to one skilled in the art, all falling within the scope of the invention as defined by the subjoined claims.

1. A method of forming a film from a PCTFE polymer, said method comprising the steps of:
a) extruding molten PCTFE polymer;
b) cooling said PCTFE polymer to a temperature below its melting point to form a film that is crystalline; and
c) orienting said PCTFE film while it in its crystalline state by stretching said film at a stretch ratio of at least about 1.5:1 while holding said film under tension;
wherein the resulting PCTFE film has a water vapor transmission rate of less than about 0.05 g/100 in²/day (0.775 g/m²/day).

2. The method of claim 1, wherein said film prior to orientation has a crystallinity of from about 10 to about 45%.

3. The method of claim 1, wherein said film prior to orientation has a crystallinity of from about 15 to about 35%.

4. The method of claim 1, wherein said PCFTE polymer comprises a homopolymer.

5. The method of claim 1, wherein said PCTFE polymer comprises a copolymer.

6. The method of claim 1, wherein said film is oriented at a stretch ratio of from about 1.5:1 to about 5:1.

7. The method of claim 1, wherein said film is oriented at a stretch ratio of from about 2:1 to about 3:1.

8. The method of claim 1, wherein said film has a water vapor transmission rate of less than about 0.03 g/100 in²/day (0.465 g/m²/day).

9. The method of claim 1, wherein said film has a water vapor transmission rate of less than about 0.015 g/100 in²/day (0.233 g/m²/day).

10. The method of claim 1, wherein said film has a water vapor transmission rate of at least less than about 20% of the water vapor transmission rate of comparable film which is unoriented.

11. The method of claim 1, wherein said film is monoaxially oriented.

12. The method of claim 1, wherein said film is biaxially oriented.

13. An oriented film produced by the method of claim 1.

14. A method of forming a film from a PCTFE polymer, said method comprising the steps of:
a) extruding molten PCTFE polymer onto a casting roll;
b) cooling said PCTFE polymer to a temperature below its melting point on said casting roll to form a film that is crystalline; and
c) orienting said PCTFE polymer film while in its crystalline state by stretching said film between at least one relatively slow draw roll and at least one relatively fast draw roll at a stretch ratio of at least about 1.5:1 while holding said film under tension; and
d) collecting said oriented PCTFE polymer film;
wherein the resulting PCTFE film has a water vapor transmission rate of less than about 0.05 g/100 in²/day (0.775 g/m²/day).

15. The method of claim 14, including the step of passing said film from said casting roll over a preheat roll prior to orienting said film.

16. The method of claim 14, wherein said casting roll is maintained at a temperature of about 50 to about 250° F. (10 to 121° C.).

17. The method of claim 14, wherein said casting roll is maintained at a temperature of about 75 to about 200° F. (24 to 93° C.).

18. The method of claim 14, wherein said draw rolls are maintained at a temperature of about 75 to about 200° F. ( 24 to 93° C.).

19. The method of claim 14, wherein said draw rolls are maintained at a temperature of about 90 to about 175° F. (32 to 80° C.).

20. The method of claim 14, wherein said film is oriented at a stretch ratio of from about 1.5: 1 to about 5:1.

21. The method of claim 14, wherein said film is oriented at a stretch ratio of from about 2:1 to about 3:1.

22. The method of claim 14, wherein said film prior to orienting has a crystallinity of from about 10 to about 45%.

23. The method of claim 14, wherein said film prior to orienting has a crystallinity of from 15 to about 35%.

24. The method of claim 14, wherein said PCFTE polymer comprises a homopolymer.

25. The method of claim 14, wherein said PCTFE polymer comprises a copolymer.

26. An oriented film produced by the process of claim 14.

27. A multilayered structure including the film of claim 26.
